(19) United States
(12) Patent Application Publication
(10) Pub. No.: US 2026/0235326 A1
(43) Pub. Date: Aug. 13, 2026

(54) SOLAR THERMAL ENERGY STORAGE AND INTEGRATED POWER GENERATION SYSTEM

(71) Applicant: EnviroMission Group, LLC, Jenks, OK (US)

(72) Inventors: Valerie Elaine Schafer, Mesa, AZ (US); Mehmet Özcan, Muenchen (DE); Christopher James Davey, Scottsdale, AZ (US); Franklin Keith Miller, Stoughton, WI (US)

(21) Appl. No.: 19/463,655

(22) Filed: Jan. 29, 2026

Related U.S. Application Data
(60) Provisional application No. 63/752,102, filed on Jan. 31, 2025.
(60) Provisional application No. 63/849,437, filed on Jul. 23, 2025.

(51) Int. Cl. F24S 80/70; F24S 10/75; F24S 80/453

(52) U.S. Cl. CPC F24S 80/70; F24S 10/755; F24S 80/453

(57) ABSTRACT

The present application describes a novel system and method for sustainable renewable electricity production and thermal energy transfer using low pressure compressed gas or heat transfer fluid, a solar energy collector unit, a thermal energy storage unit, and turbine-generators or an Organic Rankine Cycle to achieve heat storage sufficient for 24-hour dispatchable power generation and heat-related work. For additional days of storage, a greater volume of thermal energy storage is configured. Such a system can be modular, enabling small units to produce limited power or larger units to deliver greater power or heat output. Its modular design facilitates power generation and commercial thermal applications across non-contiguous land areas. The system's continuous renewable power generation capability, low operating cost, production reliability, ease of operation and long useful life advantage deployment of this novel technology throughout the developed and developing world.

### RELATED APPLICATIONS

The present application claims the benefit of and priority to U.S. Provisional Patent Application Nos. 63/752,102 filed Jan. 31, 2025, and 63/849,437 filed Jul. 23, 2025, the entire contents of which are hereby incorporate by reference.

### FIELD OF THE INVENTION

The present application relates generally to a system and method for producing electricity and/or heat and cooling service twenty-four (24) hours per day for multiple days from solar radiation. The novel system comprises a fluid, which can be either gas or liquid, a solar energy collector unit, a thermally conductive block for solar thermal energy generation and storage, and a power block utilizing at least one of a Brayton cycle or an Organic Rankine Cycle, or both. The system can be supplemented by geothermal, waste, or electric resistive heat to increase temperatures, or make them more constant within the system. Net power and heating/cooling service is supplied to the grid or end-user as described herein.

### BACKGROUND OF THE INVENTION

Embodiments of the present invention apply to electrical power generation, solar-powered turbine generation, air compression, energy storage systems, thermal storage systems, and heating and cooling services.

As a result of global environmental concerns, there is ever increasing interest in systems and processes that use renewable energy.

Solar energy has been used in many processes to generate power and heating/cooling during the daytime hours when there is sufficient sunlight.

Photovoltaic (PV), also known as solar panels, is one such method of solar power generation. However, it can only generate power during daylight hours when productive solar radiation is available. Battery storage, or natural gas generation, is required if power is to be produced and delivered at times when sufficient solar radiation is not available. To date, utility scale battery storage has been very expensive, difficult to provide, inefficient in conversion of sunlight into commercial power and of limited useful life. PV panels have the added disadvantage of requiring various rare metals to construct.

Concentrating Solar Power processes use mirrors, troughs, dishes, or multidirectional mirrors called heliostats to concentrate and amplify the solar radiation on a specific area. These processes also generate power only during periods of adequate solar radiation. They can be integrated with a high temperature storage medium, which significantly increases costs, complexity, and vulnerability to storage medium solidification during extended periods of limited sunlight, unless also integrated with a heat generating combustible fuel source.

Wind turbines also generate renewable power but are intermittent in nature, operate only within a certain range of wind speed, and are unreliable to always supply a specific power demand. Wind turbines cannot produce power when wind speeds are below or above certain limits. Their best efficiency point is at a specific windspeed, and they are less efficient at both higher and lower speeds. They are subject to a maximum efficiency called the Betz Limit of 69.3%. This is low compared to industrial turbines that have greater than 85% typical efficiency. There are environmental impacts, typically on wildlife and related to the disposal of the blades at the end of useful life. Generally located in remote areas and subject to high mechanical stress, wind turbines have experienced relatively high operating and maintenance costs.

Several processes use high pressure compressed air to drive a turbine and produce electricity. Some add an additional step to recover energy from the heated air and use that energy to produce steam. This additional step is called “combined cycle” and is a commonly used method to maximize the efficiency of electricity generation in fossil fuel plants. Some processes use Compressed Air Energy Storage for generation of electricity during periods of time when not relying on fossil fuels. This has not been economically feasible due to necessary high-pressure levels and the need for a suitable geological structure or a storage vessel rated for high pressure. The storage volume must be large enough to release sufficient air required to meet power generation needs.

Existing solar collector technology is generally categorized as either non-concentrating, consisting primarily of flat plate collectors and evacuated tube collectors typically used in residential, industrial and commercial buildings for space and water heating, or concentrating, comprised of utility scale enhancing collectors used in solar power plants to generate electricity by heating a heat-transfer fluid to drive a turbine connected to an electrical generator.

Flat plate collectors commonly operate at 50-120° C., but can reach temperatures up to 200° C. under certain conditions. Evacuated tube collectors generally operate between 60° C. and 180° C., with some specialized non-concentrating collectors with vacuum insulation and advanced coatings achieving higher temperatures. Concentrating solar collectors which amplify solar radiation through use of mirrors, troughs, dishes and other means of magnification reach temperatures exceeding 1,000° C.

### SUMMARY OF THE INVENTION

The above described disadvantages are overcome and other advantages are realized by an energy storage and generation system as described herein. The system includes a solar energy collector unit comprising a transparent cover and an absorber plate arranged on top of and coupled with a thermal energy storage unit, wherein the transparent cover is separated from the absorber plate by a sealed compartment. At least one of a compressor for gas working fluid or a pump for liquid working fluid are included. A system of conduits transmits the working fluid to the thermal energy storage unit, and then to a power block. The power block comprises at least one of a Brayton Cycle and an Organic Rankine Cycle. The absorber plate is heated by solar radiation, and the absorber plate transfers heat to the thermal energy storage unit.

In another embodiment, the system includes a solar energy collector unit comprising a transparent cover, and an absorber plate that absorbs solar radiation. The absorber plate is arranged beneath the transparent cover. The transparent cover is separated from the absorber plate by a sealed compartment, the absorber plate having channels therein containing a working fluid. The working fluid is heated by the absorber plate. The system includes a thermal energy storage unit, a compressor for gas working fluid or a pump for liquid working fluid, a conduit to transmit the working fluid heated by solar radiation to the thermal energy storage unit, and then to a power block. The power block comprises at least one of a Brayton Cycle and an Organic Rankine Cycle.

This application describes an integrated solar thermal energy generation and storage system that uses renewable resources and common materials to store heat and generate electricity continuously over extended periods. This system addresses many issues that are not solved by current renewable energy sources. Embodiments described in the present application have several advantages over existing systems, including but not limited to:
a) The system produces dispatchable renewable power and heating/cooling service 24 hours a day for multiple days at a controllable rate even if recharging sunlight is not present for extended periods.
b) The system isn't reliant on intermittent renewable resources such as wind and solar energy which can greatly vary.
c) Energy storage is an integral component of system power production technology improving efficiency and reliability.
d) No scarce materials such as lithium and cobalt are used.
e) The system components have a long lifespan, unlike many renewable energy technologies.

This solar collector technology uses solar radiation to achieve significantly higher temperatures than existing non-concentrating solar collectors due to a novel combination of a selective surface, a gap, and a thermally insulating material such as aerogel. The selective surface absorbs solar radiation while preventing re-radiation of heat from the absorber plate. The gap is thermodynamically proven to reduce the overall radiative and conductive heat losses. The thermally insulating cover allows a high transmissivity of solar radiation while providing insulation properties to retain the captured solar radiation. The novel composition of thermally optimized materials and engineered structures minimizes the losses in the system and enables the solar collector to attain and sustain high temperatures and transfer them to the storage block resulting in temperatures of approximately 200-500° C. All this is completed through a non-concentrating solar collector.

The system comprises a solar energy collector unit, a thermal energy storage unit, a heat transfer fluid or gas, and a power generation block. The method of synergistically combining the equipment, purpose-designed proprietary materials, and engineered component systems and tailoring the output of the production and storage platform to meet generation and heating/cooling service requirements continually over multiple 24-hour periods, regardless of the availability of recharging solar insolation, represents novel and unique elements of exemplary embodiments of the invention.

The thermal energy storage unit described herein uses a readily available and common continuous phase material with enhanced thermal conductivity thus enabling more cost-effective dispatchable power production, that can produce power 24 hours per day, 7 days per week, 365 days per year, which is unavailable with existing renewable power generation technologies. Higher thermal conductivity allows all of the solar-generated heat that charges or is accumulated within a thermal energy storage unit to be recovered as useful energy permitting renewable power generation and/or heating/cooling service over a much longer period. In addition, pipes or channels to heat and transport the working fluid are embedded in the thermal energy storage unit to efficiently charge and discharge the thermal energy storage unit, thus managing the power generation and/or heating/cooling cycle. The characteristics of the system allow several thermodynamic cycles to be used for power generation and heating/cooling. Solar radiation is used to heat a working fluid in the solar collector to temperatures of approximately 350° C., providing the potential for efficient power generation or heating/cooling service cycles. Both solar heat that is captured and not used directly for power generation or heating/cooling service cycles as well as residual solar-produced heat remaining after power generation or heating/cooling service cycles is advantageously stored within the integrated thermal energy storage unit for utilization at times and in amounts as required. This integrated generation and storage configuration optimizes solar resource utilization to enable improved management of power demand. That is, a solar resource can be utilized 24 hours a day as opposed to other forms of renewable power generation or heating/cooling service.

One embodiment of the present application uses an engineered solar energy collector unit coupled with a thermal energy storage unit to heat either a gas or liquid working fluid which is used to generate power. The solar radiation is converted to thermal energy that is stored in the thermal energy storage unit, heating the working fluid and maintaining heat for power generation at night and beyond. This solves a major generation problem inherent in current renewable technology-embodiments of the present application can advantageously generate power from heat stored in the thermal energy storage unit 24 hours a day for several days without solar recharge. Power generation equipment can be integrated into the system. The underlying power generation equipment is commonly used in the utility industry and widely available.

A second embodiment of the invention decouples the solar energy collector unit and the thermal energy storage unit. During the daytime, the working fluid is heated within channels or pipes in the solar collector and then flows to the thermal energy storage unit to heat the thermal energy storage media and then in a loop back to the solar energy collector unit. At the same time, the hot working fluid in a second fluid loop flows through the thermal energy storage unit countercurrent to the hot fluid directly to the power block to generate power. At night or during periods of low insolation, the solar energy collector unit is bypassed, and the second fluid loop continues to utilize heat stored in the thermal energy storage unit to provide ongoing power production.

In addition, the second embodiment of the system can be managed to accumulate heat in greater quantity and temperature in the thermal energy storage unit during hours of sunlight and then produce a higher amount of power during periods of peak demand than the first embodiment. The working fluid flow rate can be controlled as well to manage production to follow a power demand curve or meet varying heating/cooling service requirements. This process can produce power for the electrical grid, or it can produce electricity for a standalone facility such as a data center. This process can also provide heating/cooling capability in addition to power production for dedicated multi-utility service customers.

### BRIEF DESCRIPTION OF THE DRAWINGS

The various objects, advantages and novel features of the exemplary embodiments of the present application will be more readily appreciated from the following detailed description when read in conjunction with the appended drawings in which:

FIG. 1 depicts the Brayton Cycle utilized in exemplary embodiments of the present application;

FIG. 2 illustrates the thermodynamic cycle of an ORC utilized in exemplary embodiments of the present application;

FIG. 3 illustrates the impact of various cover arrangements on the temperature of the absorber system;

FIG. 4 is a system diagram of an exemplary embodiment of the present application;

FIG. 5 is a side cross sectional view of a thermal energy storage unit for use in exemplary embodiments of the present application;

FIG. 6 is a system diagram of a second exemplary embodiment of the present application;

FIG. 7 is a system diagram of a third exemplary embodiment of the present application;

FIG. 8 illustrates a piping configuration for use with the second and third exemplary embodiments;

FIG. 9 illustrates another piping configuration for use with the second and third exemplary embodiments; and

FIG. 10 shows an example of a tilted collector system.

Throughout the drawings, like reference numbers should be understood to refer to like parts, components, features and structures.

### DETAILED DESCRIPTION OF THE EXEMPLARY EMBODIMENTS

As will be described in detail below, embodiments of the present application store solar energy in the form of heat and utilize that heat to generate electricity. Advantageously, sufficient heat is stored to continue generating electricity through at least one night, and the thermal energy storage unit is charged with heat during a subsequent daylight period. The components of such a system include a compressor (for gas), or a pump (for fluid), to move working fluid through the system, a solar energy collector unit to absorb solar radiation and store heat, a series of conduits or pipes that move working fluid through the heated thermal energy storage unit to heat the working fluid, a turbine to utilize the heated working fluid to perform mechanical work, and a generator to transform the mechanical work of the turbine into electrical power. Several different configurations are contemplated, as will be described below, including systems with a single loop of working fluid, and dual-loop systems with two separate loops of working fluid that transfer heat between loops. The total electrical power produced by the system is greater than the input power required to run the compressor and any other ancillary equipment, such that the system generates net electrical power. This system is also capable of providing heating and cooling services in addition to generating power.

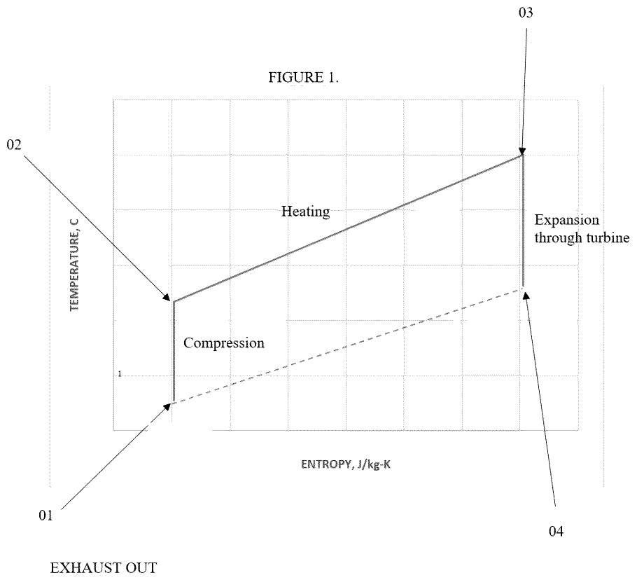

Embodiments of the present application can be configured to utilize both the Brayton and Organic Rankine Cycles depending on specific application and need. The Brayton thermodynamic cycle is shown In FIG. 1. Point 01 is gas at ambient temperature and pressure. Point 02 represents the isentropic compression of the gas, which raises the temperature of the gas by about 10-200° C. From point 02 to point 03, the compressed gas is heated using the heat from solar radiation captured in the solar collector and thermal energy storage unit.

From point 03 to point 04, the hot, compressed gas is expanded across a turbine. This causes the temperature and pressure of the gas to decrease, which releases additional energy. From point 04 back to point 01, the gas is cooled back to ambient temperature and pressure. The Brayton Cycle used here is an open Brayton Cycle. The gas at point 04 is discharged directly to the atmosphere or to an Organic Rankine Cycle for further heat recovery. The total work done is represented by the area within the box that is depicted in FIG. 1. This total work represents the work required to compress the gas along with the net electrical generation.

The Brayton Cycle is a gas phase process, whereas the Organic Rankine Cycle (ORC) has a phase change from liquid to gas and back to liquid. The ORC process is a closed-cycle system using organic fluids such as cyclopentane, ethanol, or toluene. The ORC working fluid is vaporized using heat from the thermal energy storage unit. The vapor is expanded across a turbine to produce mechanical work which is converted to electricity. The vapor is then condensed to a fluid and is pumped back to the vaporizer to complete the cycle.

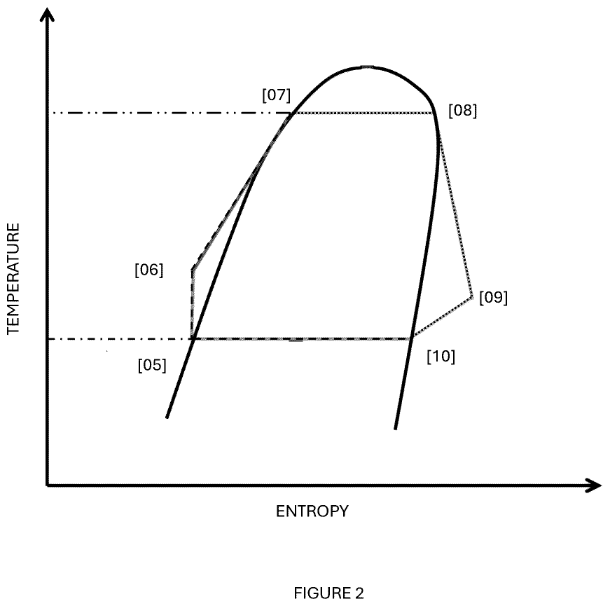

FIG. 2 illustrates the Organic Rankine Cycle (ORC). The ORC is a closed loop system used for generating electricity from low to medium temperature heat sources. The ORC is a modification of the traditional steam Rankine Cycle. Instead of water/steam, ORCs use organic compounds that have better generation efficiencies at lower heat-source temperatures than water as the working fluid. In a Rankine Cycle, a liquid ORC working fluid such as cyclopentane, toluene, or ethanol, is pumped to elevated pressure before entering a heat recovery boiler. The pressurized fluid is vaporized using the heat from the system and then expanded to lower temperature and pressure in a turbine, generating mechanical power that can drive an electric generator. The low-pressure working fluid is then exhausted to a condenser where heat is removed by condensing the vapor back into a liquid. The condensate from the condenser is then returned to the pump and the cycle is repeated.

FIG. 2 shows the thermodynamic cycle of the ORC. The Brayton Cycle is an all gas phase, whereas the ORC has a phase change from liquid to gas and back to liquid. The ORC working fluid is pumped from a lower pressure to a higher pressure (5 to 6). The high-pressure liquid goes through the recuperator to pick up heat from the expanded vapor exiting the expander (6 to 7). Then the high-pressure fluid enters a boiler where it is heated at a constant pressure until it becomes a dry saturated vapor (7 to 8). Next, this vapor expands through a turbine where mechanical work is converted into electrical energy (8 to 9). The high temperature vapor goes through the recuperator to be cooled by the liquid exiting the condenser (9 to 10). The wet vapor then enters a condenser where it is condensed back into a saturated liquid and the cycle starts again (10 to 5).

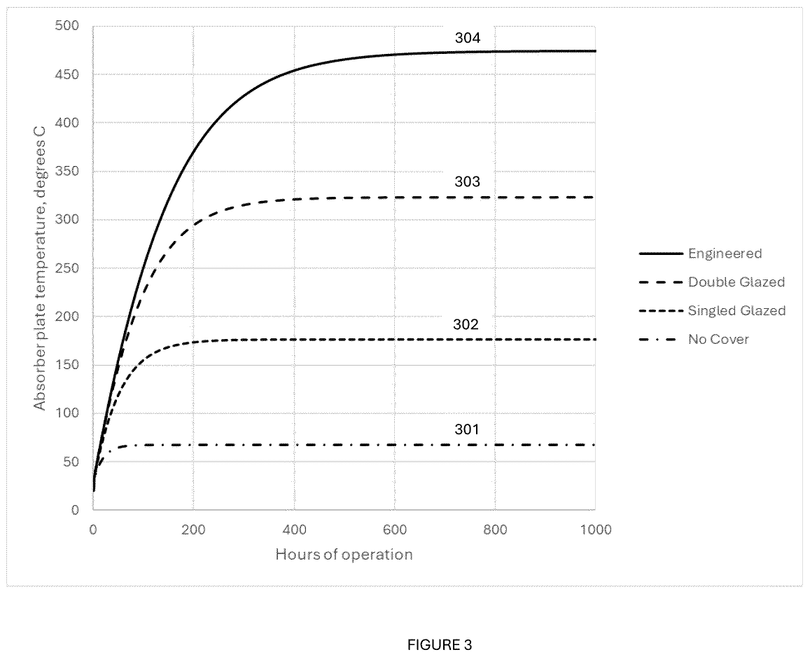

FIG. 3 depicts the impact of the temperature of the thermal energy storage unit with no solar collector cover and with three other types of solar collector covers. The solar energy collector unit, described in further detail below, is required to ensure the thermal energy storage unit can reach and maintain the required temperatures. FIG. 3 illustrates the dependency of the two components, the thermal energy storage unit and the solar energy collector unit, and compares the top surface temperature vs time for four cases. The first case 301 is an uncovered thermal energy storage unit. The second case 302 depicts the temperature profile for a thermal energy storage unit with a single layer of glass as a collector. The third case 303 is the temperature profile with a double-paned collector. The fourth case 304 achieves the highest temperature utilizing a novel solar energy collector unit. The solar energy collector unit consists ideally of a selective surface for absorbing solar radiation while reradiating little heat, an air gap, and a cover which is aerogel or a similar transparent insulation material.

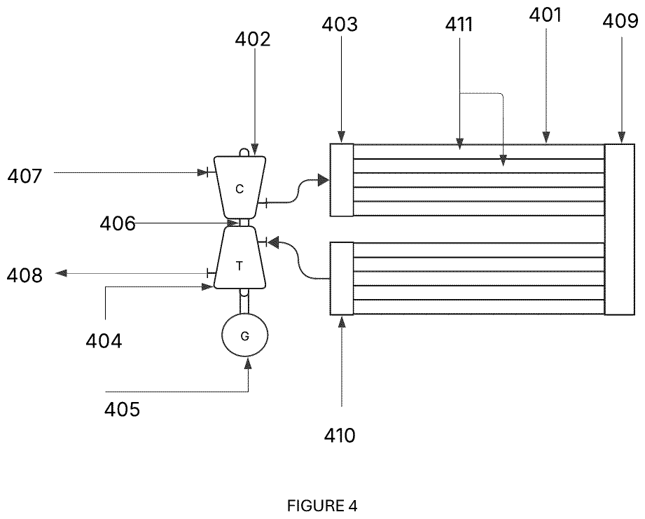

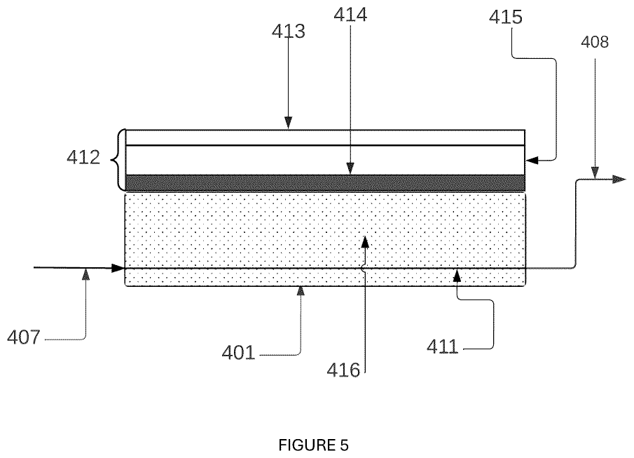

FIG. 4 depicts a first exemplary embodiment of the present application. The system includes a coupled solar collector system and thermal energy storage unit 401 coupled with a compressor 402, turbine 404, and generator 405 on a single shaft 406. Of course, a single shaft is convenient but should not be considered limiting. Other configurations of the components of the system are considered within the scope of the present application. For example, the compressor 402 could be on one side of the coupled solar collector system and thermal energy storage unit 401, with the turbine 404 and generator 405 arranged on the other side, such that working fluid flows in one direction from the compressor side to the turbine side. In the configuration illustrated in FIG. 4, a pipe or series of pipes 411 have inlet 403, return 409, and outlet 410 headers. Compressor 402 is preferably powered by power output from the generator 405. Compressor 402 propels working fluid 407 (here in gas form) through the coupled solar collector system and thermal energy storage unit 401. The expanded gas 408 exits the turbine 404. Not shown in FIG. 4 but illustrated in FIG. 5 in side elevation view is a coupled collector system that heats the thermal energy storage unit 401 with primarily solar energy.

FIG. 5 depicts the side view of the coupled thermal energy storage unit. The thermal energy storage unit 401 is composed of a thermally conductive material 417. The working fluid 407 enters a pipe or channel 411 in the thermal energy storage unit 401. A collector system 412 is arranged on top of the thermal energy storage unit 401. The collector system 412 includes an absorber plate 414 and a transparent cover 413. A sealed compartment 415 is preferably arranged between the transparent cover 413 and the absorber plate 414. The sealed compartment 415 is preferably very low pressure or vacuum or filled with air or other gases such as argon. Transparent cover 413 ideally is transparent and transmissive to solar radiation, and prevents heat loss. Absorber plate 414 absorbs solar radiation to become hot, transferring heat into the thermal energy storage unit 401. As stated above, working fluid flowing through the thermal energy storage unit 401 is heated by the thermal energy storage media prior to exiting the thermal energy storage unit 401 at 408 and operating on the turbine 404 (as shown in FIG. 4).

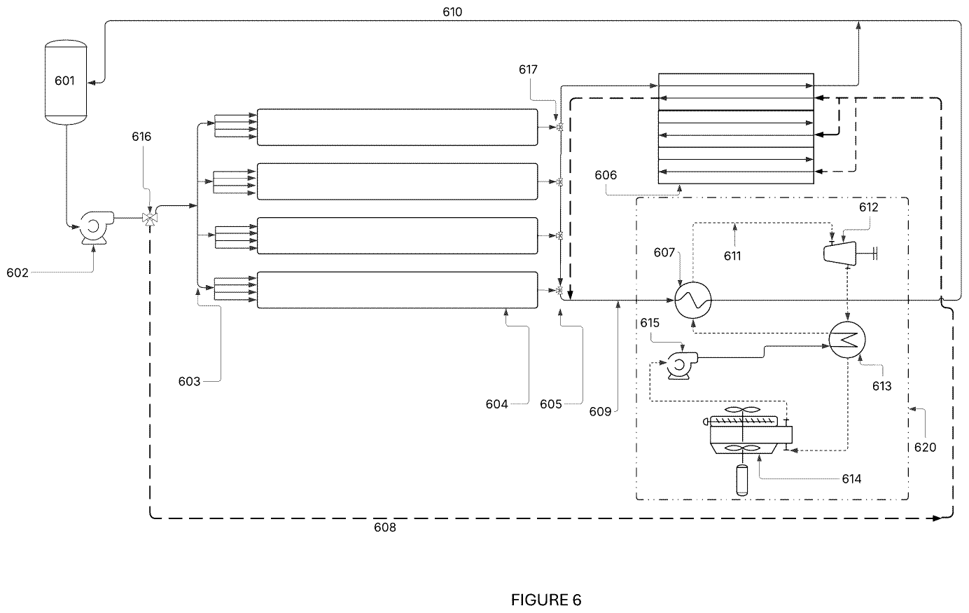

FIG. 6 illustrates a second embodiment of the present application. A tank 601 of working fluid feeds a pump 602. During periods of sunlight, all the working fluid is routed through the collector system 604 through manifold 603. Control valves 617 route part of the hot fluid to the thermal energy storage unit 606 to charge it for nighttime/low insolation periods and route part of the hot fluid to the vaporizer 607 for the ORC. The cooled fluid from the outlet of the thermal energy storage unit 606 and from the outlet of the ORC is recycled back to the tank 601 via the return pipe 610. During night or periods of low insolation, control valve 616 is closed so that the working fluid is bypassed through line 608 around the solar collector system 604 directly to the thermal energy storage unit 606, where it gains heat and flows to the ORC vaporizer 607. In addition, the hot fluid in the solar collector is collected in tank 601 during the night or during periods of low insolation to conserve the heat in the fluid.

In the ORC, the working fluid 611 is preheated in the recuperator 613 and then vaporized in the vaporizer 607. The vaporized fluid is expanded across turbine generator 612 to produce electricity. The fluid is then cooled in the recuperator 613 and condensed in the air cooled heat exchanger 614. The liquid fluid flows to pump 615 where the cycle begins again.

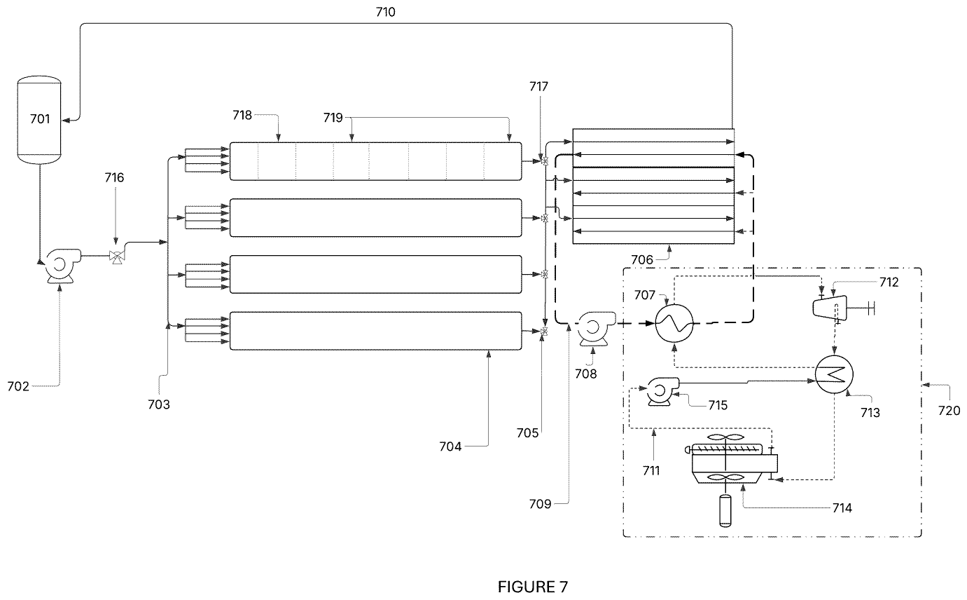

FIG. 7 illustrates a third embodiment of the present application. A tank 701 of working fluid feeds a pump 702. During periods of sunlight, control valve 714 is set so that the working fluid is routed through the solar collector system 704 through manifold 703. During nighttime periods or no insolation, control valve 716 is closed and the hot fluid in the solar collector is collected in tank 701 to conserve the heat in the fluid. Control valves 717 on the manifold 705 on the hot end of the solar collector 704 allow for variation of flow to the solar collector panels 716 or the thermal energy storage unit 706. The hot fluid is routed to the thermal energy storage unit 706 to charge it for nighttime/low insolation periods and to heat the fluid 709 for the vaporizer 707 of the ORC. The cooled fluid from the outlet of the thermal energy storage unit 706 is recycled back to the tank 701 through the return line 710. The collector system is advantageously divided into multiple panels 718. Each panel has segments 719 which represent different temperature zones and allows the possibility of use of different construction materials.

In the ORC, the working fluid 711 is preheated in the recuperator 713 and then vaporized in the vaporizer 707. The vaporized fluid is expanded across turbine generator 712 to produce electricity. The fluid is then cooled in the recuperator 713 and condensed in the air cooled heat exchanger 714. The liquid fluid flows to pump 715 where the cycle begins again. A second pump 708 is used for a second separate circulation loop for heating the vaporizer 707.

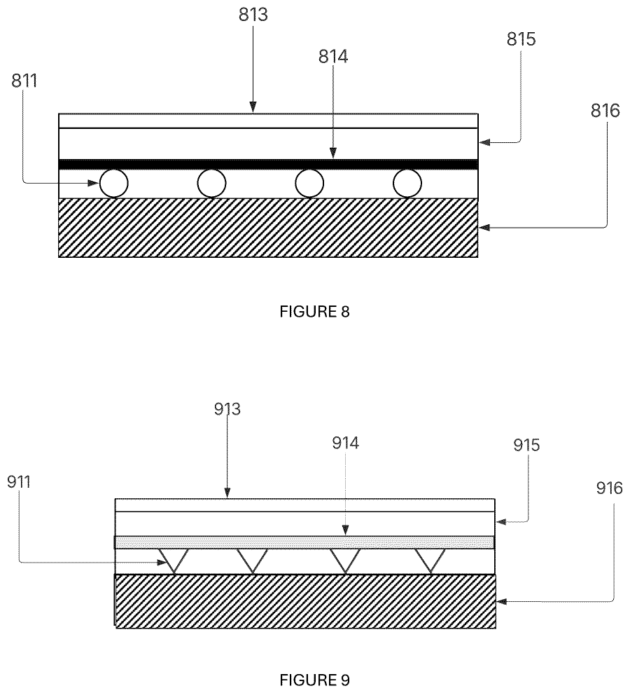

FIG. 8 illustrates a first exemplary piping configuration for the decoupled solar collector 604,704. The clear cover 813 and absorber plate 814 are positioned on top of a series of round pipes or channels 811, such as in a roll-formed aluminum sheet. There is an air or other gas gap 815 between the clear cover 813 and the absorber plate 814. A layer of insulation 816 prevents heat losses from the system.

FIG. 9 illustrates a second exemplary piping configuration for the decoupled solar collector 604,704. The clear cover 913 and absorber plate 914 are positioned on top of a series of V-shaped, rectangular, or semi-circular channels 911. There is an air or other gas gap 915 between the clear cover 913 and the absorber plate 914. Only V-shaped channels are illustrated, but as one of ordinary skill in the art will appreciate, any suitable shape may be utilized. A layer of insulation 916 prevents heat losses from the system.

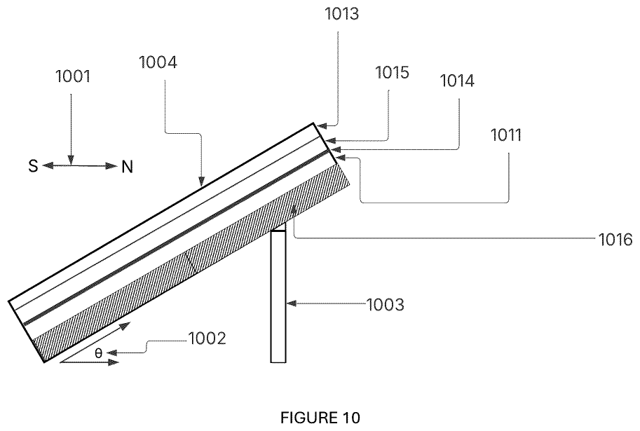

FIG. 10 illustrates an exemplary tilted collector 1004. It is preferably tilted towards the south 1001 in the Northern Hemisphere and to the north in the Southern Hemisphere. The angle of tilt 1002 is 0° to 30°. The collector cover 1013, absorber plate 1014, air or gas gap 1015, space where the pipes or channels run 1011, and insulation 1016 are shown. The collector has a fixed or adjustable support 1003 to enable solar tracking. As well, the tilt angle 1002 can be achieved partially or fully by civil works (ground engineering) instead of or in addition to the support 1003.

In the above described embodiments, the solar energy collector unit 412, 604, 704 consists of a black-coated or selective surface functioning as the collector absorber 414, 814,914,1014 with a collector cover 413,813,913,1013 made from transparent insulating material such as vacuum-insulated glass or aerogel over part or all of the collector absorber. It includes a gap filled with air or other gas 415,815,915,1015. The engineering of the solar energy collector unit is designed to reach temperatures of 150-500° C.

The transparent insulating material may include multiple layers including glass, ETFE, FEP, polycarbonate, air, argon or other gas-filled gaps, or other layers to minimize convective heat losses to the atmosphere. The clear collector cover is designed to have high transmissivity of solar radiation while also protecting against convective and radiative heat losses. There is a balance between the number of layers, the transmissivity, and the minimization of heat losses as too many layers will reduce the solar transmissivity, and too few layers will increase heat losses.

The collector absorber can comprise of a metal plate which can have a selective surface or can be black. A selective surface is a metal surface coated with chemical compounds that are engineered to interact differently with various wavelengths of radiation, typically by having high absorption of short-wavelength solar energy (visible light) and low emission/high reflection of long-wavelength thermal infrared radiation. A black surface absorbs solar radiation but also has higher radiative losses at higher temperatures. The use of these two types of surfaces can be combined by engineering the design of the collector segments based on temperature. For example, in the cooler segments near the start of the collector system, a black surface may be sufficient as radiative losses are lower at lower temperatures. In the hotter segments towards the exit of the collector system, a selective surface would be warranted to reduce radiative losses.

The collector system can be divided into multiple panels, or sections running from the start of the solar collector to the end, which facilitate construction, maintenance, tracking, reflection, concentration, and other solar thermal enhancement features. Each panel 718 is preferably arranged into segments 719 as shown in FIG. 7. The segments 719 of the solar collector will be engineered according to the properties required for each segment of the collector system. For instance, the solar energy collector unit materials at the beginning of the panel may not be the same as at the end where it will be at its hottest.

Anti-reflective coatings, IR-reflective coatings, and other specialized coatings, on the surfaces of the collector cover are used to minimize radiative heat losses. Other enhancements to the collector system, like shutters or louvers and insulation materials to prevent losses at night or periods of low insolation may be incorporated to further reduce losses and increase the efficiency of the system.

Solar radiation absorbed by the collector system (and thus heat) can be enhanced by adding solar reflectors, mirrors, panels, magnifiers, heaters and other related equipment. These can be directed to the hotter segments of the collector system to optimize the outlet temperature and the collector system size.

The collector system is closed at the edges to prevent system impact of wind or dust, and importantly the movement of air across the collector absorber that would result in convective heat transfer losses and thus, reduced power generation or utility service efficiency. The gap between the collector cover and the absorber plate provides additional heat retention. It can be at near-vacuum or be composed of air, argon, or other gases.

In addition, the solar energy collector unit is designed to include mirrors, troughs, dishes and other means of magnification to produce elevated temperatures for power generation or heating/cooling utility service applications requiring higher thermal output.

The fluid flowing through the collector system can be either a compressed gas such as air, CO₂, or nitrogen, or a liquid such as a hydrocarbon-based heat transfer fluid, water, or glycol. These are collectively known as the working fluid. The purpose of the working fluid is to collect heat from solar radiation and use it to make electricity.

The thermal energy storage unit is the storage medium integral to the system's power generation and storage process. Examples of materials that can be used in the thermal energy storage unit include, but are not limited to, concrete of all types including geopolymer concrete and calcium aluminum cement concrete, cement, ceramics, treated sand or soil, quartz, or silicon compounds. Although it is thermodynamically possible to exceed temperatures of 500° C. with the solar energy collector unit, a balance is required due to the integrated nature of the system's thermal energy storage. The temperature limit for the storage is a key factor when designing both components of this novel solar thermal storage and generation system.

The thermal energy storage unit is preferably designed for a minimum of 48 hours of power production or heating/cooling utility service. Based on the thermal properties of the thermal energy storage unit; that is, mass and specific heat capacity; the nighttime production of approximately 10-14 hours is easily accomplished and results in only a 20-50° C. drop in the average temperature of the thermal energy storage unit. During the day, the thermal energy storage unit quickly returns to a fully charged state, that is, it is brought back to the temperature achieved during daytime operations. The composition of the thermal energy storage unit ensures that the storage medium can discharge heat when required and charge at times of solar irradiance.

The system recovers nearly all heat input into the thermal energy storage unit as energy. Higher thermal conductivity increases exergy or recoverable energy, increasing system efficiency and thus power generation and storage for later production or utility services.

The optimum thermal conductivity is impacted by the required amount of storage, thickness of the thermal energy storage unit, mass of the thermal energy storage unit, specific heat of the thermal energy storage unit material, and capital cost of the materials required to reach higher levels of conductivity.

Heat capacity determines energy storage in the thermal energy storage unit, with a typical value of 880 J/kg-° C. for a concrete-based material. Even at a thickness of 0.125 m, the thermal energy storage unit stores sufficient energy to permit continuous power generation for extended periods. Heat storage is calculated as:

$$mass [ kg ] \times specific heat [ J / kg - °C . ] \times delta T [ °C . ] \times 1 / hr .$$

A 25-50° C. temperature swing during times of no solar radiation (nighttime), will still allow for continuous generation at night. The temperature drop is primarily due to the transfer of heat to the working fluid for continuous power production. The thermal energy storage unit will preferably be sized to provide a minimum of 48 hours of storage to produce power during periods of no or low solar radiation, such as on rainy days. The amount of storage increases linearly with block size provided there is sufficient thermal conductivity for the thermal energy storage unit depth.

At the latitudes expected for deployment of the systems, on the longest day of sunlight during the year, there are 14 hours of solar radiation and 10 hours without solar radiation. On the shortest day of sunlight during the year, there are 10 hours with solar radiation and 14 hours without solar radiation. Other times, such as during rainy periods, the thermal energy storage unit would still be able to heat the working fluid due to the amount of storage in the thermal energy storage unit. The working fluid reaches temperatures of between 150-450° C. and is used to produce electricity and utility services, sustaining operation even without solar radiation. During periods of no, or limited solar radiation, the heat retained within the thermal energy storage unit advantageously heats the working fluid to produce electricity and utility services. The temperature ranges provided are indicative, and a temperature range may be selected based on desired generation performance, geographic location, and production profile.

The system is modular and can be sized to provide sufficient heat to meet the anticipated capacity for each modular system unit from 0.5 MW-60.0 MW or higher of net hourly electricity generation. Multiple systems can be constructed and interconnected to provide heat storage for a wide range of power generation and utility service requirements, including for hundreds of MW. Production capacity is limited to the output of existing generation equipment; with more efficient power generation equipment electricity capacity factors can be expected to increase.

The power block is preferably based on standard electricity producing equipment but operates at lower temperatures and pressures. It can be a Brayton Cycle followed by an Organic Rankine Cycle, or a Brayton Cycle, or an Organic Rankine Cycle operating independently.

The Brayton Cycle is used to extract power from compressed, heated gas. Air is drawn from the atmosphere into a compressor, where it is compressed reversibly and adiabatically. Adiabatic compression means that heat does not enter or leave the gas, therefore, the gas temperature increases to 80-200° C. In a typical Brayton cycle, a combustion process, generally fossil-fueled, is used to heat the gas. In the system, solar radiation is used to heat the gas. The compressed gas flows through the thermal energy storage unit to be heated. The gases then expand isentropically in the turbine. A large portion of the work obtained from the turbine is utilized to drive the compressor and the auxiliary drive and the rest of the power output is the net power of the generation plant. The waste heat from the Brayton Cycle can generate electricity in an Organic Rankine Cycle.

In the first embodiment of the invention, the collector system and thermal energy storage unit are combined and referred to as the coupled system. That is, the collector system is placed on top of the thermal energy storage unit, with the collector absorber on top of the thermal energy storage unit. The thermal energy storage unit is heated directly by solar radiation.

The thermal energy storage unit's thickness can range from 0.10-3.0 m depending on configuration and storage requirements, and can have conductivity values of 2.0-18 W/m−K.

The working fluid is heated using pipes, precast concrete tubes, or any other suitable conduit embedded in the lower half of the thermally conductive thermal energy storage unit.

The thermal energy storage unit can be built in the ground with the top surface exposed. In this case, the earth at the bottom and surrounding the sides of the thermal energy storage unit acts as additional insulation. Alternatively, the entire thermal energy storage unit is positioned above the ground. In this case, its sides would preferably be thermally insulated to prevent heat loss. In either case, insulation is arranged where needed to minimize heat losses.

The solar energy collector unit and thermal energy storage unit preferably face south in the northern hemisphere and north in the southern hemisphere for optimal solar exposure and the collector or thermal energy storage unit, or combination thereof, optionally tilt up to 65° to more efficiently capture winter sunlight as shown in FIG. 10. This is because the total solar radiation that reaches the thermal energy storage unit is a function of the zenith angle. The Global Horizontal Irradiance (GHI) is equal to the Direct Normal Irradiance times the cosine of the angle of the sun plus the Diffuse Horizontal Irradiance. Angling the solar collector reduces the zenith angle and thus increases the GHI. The optimum tilt is a function of the site latitude. Practically, a tilt of 0-30° is more likely to be constructible and economical. A practical level of tilting the collector will increase the solar radiation captured by approximately 25%. The tilting of the collector could be achieved utilizing the slope of the ground via civil engineering works, or via a structural system that facilitates the tilt of the collector.

The tilt can be fixed or adjustable. Reflective louvers can be added to direct light to the solar collector and thermal energy storage unit for enhanced radiation in specific orientations, with east-west louvers capturing light during early mornings and late evenings. Other mirror configurations, whether fixed or tracking, could also be utilized to redirect more of the sun's energy onto the collector and thermal energy storage unit.

The tilt can be variable according to the month and angle of the sun. A fixed tilt can also be used which maximizes year-round production based on the latitude of the site.

In the second embodiment of this invention, the collector system and thermal energy storage unit are decoupled, and there are two separate fluid loops. The collector system will have pipes or channels beneath an absorber plate as shown in FIGS. 8 and 9 that will heat the working fluid as it passes from one end of the solar collector system to the other, at which point the heated fluid will either heat the thermal energy storage unit or flow directly to the ORC. This embodiment has the advantage of allowing the thermal energy storage unit to be insulated on all sides, thus reducing overall heat losses and increasing the system efficiency. The thermal energy storage unit in this configuration is not subject to convective or radiative losses. This is particularly significant at night, when the night sky temperature drops and the losses would be high. When determining the sky temperature, it is assumed to be a blackbody which exchanges infrared radiation with the earth. The sky temperature can be below 0° C. when the ground temperature is 30° C. Therefore, insulating the thermal energy storage unit eliminates these high radiative losses to the sky. An additional advantage is that the collector system panels can be placed on a fixed or variable tilt at a much lower cost than attempting to tilt the entire thermal energy storage unit and collector system, which increases the yearly average incident solar radiation provided to the system, improving generation efficiency, total MWh production, and overall cost of generation.

The thermal energy storage unit can be poured concrete, or it can consist of a series of specially engineered precast hollow core (a series of hollow tubes) slabs that are stacked on top of each other or any other practical layout. Hollow core concrete advantageously has a lifespan of 100 years. Typical hollow core slabs have a depth of up to 0.5 m (19.685″) and a length of up to 18 m (59′). The working fluid flows through the channels, pipes, or hollow cores in each slab, thus allowing the use of a lower thermal conductivity as low as 2.0 W/m−K. A lower thermal conductivity can be used because the conduits or pipes will run through the middle of the thermal energy storage unit whereas in the coupled system (first embodiment), the pipes are at the bottom of the thermal energy storage unit.

In the second embodiment with the decoupled collector system and thermal energy storage unit, the working fluid in the system can be either gas or liquid. FIG. 6 shows one possible configuration for the second embodiment. In this configuration, the working fluid is stored in a tank 601 and pumped by a pump 602 through the collector system 604. In the case of a gas system, the pump would be replaced by a low-pressure compressor. During periods of solar radiation, part of the working fluid is routed to the thermal energy storage unit 606 to charge the thermal energy storage unit and part is routed directly to the vaporizer 607 in the power block. In FIG. 6, the power block 620 is shown as an ORC. At night or during periods of no or low solar insolation, control valves are set such that the working fluid bypasses the collector system 604 and is directed to the thermal energy storage unit 606 where it is heated via the stored heat in the thermal energy storage unit 606 and sent to the power block 620.

In the third embodiment, all of the working fluid flows through the collector system 704 to the thermal energy storage unit 706 as shown in FIG. 7. A separate fluid loop 709 which may be the same as the collector system working fluid or may be a different working fluid, flows in reverse through the thermal energy storage unit 706 to be heated and sent to the power block 720. During periods of no or low insolation, control valves are operated such that the working fluid is shut off to the collector system, and only the fluid loop 709 runs to recover heat from the thermal energy storage unit 706, and then to the ORC power block 720. In this embodiment, the fluctuations in temperature of the thermal energy storage block 706 and the ORC fluid loop 709 will advantageously be less between sunlight day and night, which provides more stable power production and increased generation efficiency.

The thermal energy storage unit 606/706 can contain phase change material (PCM) which melts when the thermal energy storage unit 606/706 is heated during the sunlight day and solidifies during the night or periods of low insolation, thus giving off latent heat. These PCMs have the effect of reducing the required size of the thermal energy storage unit for a given amount of thermal storage. Depending on the types of PCMs used, the size of the thermal energy storage unit can be reduced by a factor of up to three compared to concrete without PCMs. The types of PCMs used in the temperature range up to 400° C. are salt hydrates, metals, and eutectic alloys (gallium and indium-tin and also enhance the thermal conductivity of the thermal energy storage unit.

The ability to incorporate the decoupled system as described in the second and third embodiments as part of the concrete structure of a building or parking garage, including the foundations is advantageous. Such a configuration advantageously saves land area.

In exemplary embodiments, heat extracted from an external heat source, like a geothermal resource or waste heat from gas-fired combustion turbines, industrial processes or data centers, can be augmented with the system. The external heat source would also reduce the required size of the thermal energy storage unit, allow the thermal energy storage unit to generate and store more heat and more power and utility services, or remove reliance on solar energy altogether.

The modular nature of exemplary embodiments described herein allows tailoring of generation solutions to meet power production needs varying from 0.5 MW to hundreds of MWs. For example, a 600 MW unit can be comprised of ten 60 MW units, each with its own dedicated power block. If the need for power grows, additional units can be added. This modular nature also permits the use of common critical equipment spares providing greater resiliency in operations and maintenance. An equipment spare is a piece of equipment like a pump or compressor, or it is a system like an engineered solar collector system panel or ORC power plant. The use of spares allows for equipment to be taken out of service for planned or unplanned maintenance. The use of common spares reduces capital costs.

The efficiency of the thermal energy storage unit combined with the thermodynamic power generation cycles, allows exemplary embodiments to generate power and provide utility services on smaller areas of land than traditional solar PV, and other solar and wind technologies. This efficiency is a product of more efficient solar energy capture and the integrated nature of the system thermal energy storage; both generation and storage are designed and incorporated into a single integrated system.

Exemplary embodiments of the present application provide a novel electrical power generation process which uses low pressure gas compression or fluid, solar energy, a solar energy collector unit, and thermal energy storage unit to produce dispatchable renewable electricity from turbine generators and provide heating/cooling utility services 24 hours a day.

Exemplary embodiments of the present application allow modular renewable power generation on non-contiguous plots of land for use in any area, including crowded urban areas.

Exemplary embodiments of the present application could serve as either a distributed or a centralized renewable power source, either supplying electricity directly to a customer or supplying the grid.

Exemplary embodiments of the present application could see the available power (heat) being used for district heating and cooling rather than electricity generation.

Exemplary embodiments of the present application produce dispatchable sustainable electricity 24 hours a day with a smaller footprint than other renewable technologies.

Exemplary embodiments of the present application provide continuous electricity without reliance on back-up batteries or fossil fuel generation to meet evening or nighttime demand and periods of limited solar insolation.

Exemplary embodiments of the present application will be producing electricity in a firm (non-intermittent) manner removing the requirement for fossil-fueled back-up generation or batteries to firm the power being delivered to the end user or utility.

Exemplary embodiments of the present application are anticipated to provide electricity at a more reliable and lower cost than conventional renewable technologies.

Exemplary embodiments of the present application are expected to have a useful life that far exceeds that of conventional electricity generating resources.

Exemplary embodiments of the present application can produce a vast amount of clean electricity without reliance on water for power generation.

Exemplary embodiments of the present application are expected to have a useful life significantly longer than traditional electricity generation methods.

An exemplary embodiment provides reliable electricity production, eliminating the need for natural gas lines or batteries to stabilize power delivery for end-users or utilities.

The thermal energy storage unit could be used to provide heat for industrial purposes and district heat/cooling applications in addition to its primary purpose of producing renewable electricity from the capture of solar energy.

An exemplary thermal energy storage unit produces heat without the production of greenhouse gas emissions.

An exemplary thermal energy storage unit advantageously does not rely on rare earth materials.

An exemplary embodiment of the present application uses readily available construction materials and off-the-shelf component equipment.

Design simplicity, wide-spread availability of materials and components, and ease of operation, allow exemplary embodiments of the present application to be utilized throughout the world to offer lower-cost, more reliable, renewable electricity to many underserved populations in urban and remote locations than competing renewable technologies.

An exemplary embodiment of the present application is advantageously integrated and self-contained enabling power to be generated in remote locations off-grid world-wide without need for access to diesel fuel, natural gas, other fossil fuels, or battery backup.

The terminology used herein is intended to describe specific exemplary embodiments and does not limit by descriptive wording the applications of this technology to the intended purposes. Terms such as “and/or” encompass all combinations of listed items. Singular forms like “a,” “an,” and “the” include plural forms unless context indicates otherwise. The term “comprising” refers to the presence of stated features or components but does not exclude additional features or components. As will be appreciated by those of ordinary skill in the art, the descriptions presented herein are exemplary, provided for an understanding of the invention, and are not intended to be limiting. Changes and modifications to the examples provided herein may be made without departing from the scope and spirit of the invention.

What is claimed is:

1. An energy storage and generation system comprising:
a solar energy collector unit comprising a transparent cover and an absorber plate arranged on top of and coupled with a thermal energy storage unit, wherein the transparent cover is separated from the absorber plate by a sealed compartment;
at least one of a compressor for gas working fluid or a pump for liquid working fluid;
a system of conduits to transmit the working fluid to the thermal energy storage unit, and then to a power block;
the power block comprising at least one of a Brayton Cycle and an Organic Rankine Cycle;
wherein the absorber plate is heated by solar radiation, and the absorber plate transfers heat to the thermal energy storage unit.

2. The system of claim 1, wherein a pressure ratio of atmospheric pressure to an outlet pressure of the compressor or the pump is in a range from 1.2 to 5.

3. The system of claim 1, wherein at least one pipe is embedded in the thermal energy storage unit comprising thermally conductive material.

4. The system of claim 1, wherein the thermal energy storage unit has a thickness of 0.125 m to 3.0 m.

5. The system of claim 1, wherein the solar energy collector unit comprises side surfaces to enclose the thermal energy storage unit.

6. The system of claim 1, wherein the transparent cover comprises two panes of transparent material separated by a space therebetween, and wherein a substantial vacuum is formed in the space, or an aerogel material is placed in the space.

7. The system of claim 1, wherein the system incorporates geothermal heat, other waste heat streams, or electrical resistive materials instead of or in addition to solar radiation.

8. The system of claim 1, wherein the absorber plate reaches 150° C.

9. The system of claim 1, wherein the absorber plate reaches 500° C.

10. The system of claim 1, wherein the composition and volume of the thermal energy storage unit stores sufficient heat to provide 24 hours of power generation.

11. The system of claim 1, wherein the sealed compartment is filled with one of:
substantial vacuum, argon gas, or air.

12. The system of claim 1, wherein the transparent cover transmits solar radiation, and minimizes radiative and convective heat loss.

13. An energy storage and generation system comprising:
a solar energy collector unit comprising a transparent cover, an absorber plate that absorbs solar radiation, the absorber plate arranged beneath the transparent cover, the transparent cover separated from the absorber plate by a sealed compartment, the absorber plate having channels therein containing a working fluid, wherein the working fluid is heated by the absorber plate;
a thermal energy storage unit;
a compressor for gas working fluid or a pump for liquid working fluid;
a conduit to transmit the working fluid heated by solar radiation to the thermal energy storage unit, and then to a power block;
wherein the power block comprises at least one of a Brayton Cycle and an Organic Rankine Cycle.

14. The system of claim 13, wherein a pressure ratio of atmospheric pressure to an outlet pressure of the compressor or the pump is in a range from 1.2 to 5.

15. The system of claim 13, wherein the solar energy collector unit comprises separate panels which can be independently operated, including tilting.

16. The system of claim 13, wherein at a hot end of the solar energy collector unit, final sectors have fixed or tracking mirrors or enhancers to provide additional heat.

17. The system of claim 13, wherein the absorber plate reaches 150° C.

18. The system of claim 13, wherein the absorber plate reaches 500° C.

19. The system of claim 13, wherein the transparent cover comprises two panes of transparent material separated by a space therebetween, and wherein a substantial vacuum is formed in the space, or an aerogel material is placed in the space.

20. The system of claim 13, wherein the composition and volume of the thermal energy storage unit stores sufficient heat to provide 24 hours of power generation.

21. The system of claim 13, wherein at least one pipe is embedded in the thermal energy storage unit comprising thermally conductive material.

22. The system of claim 13, wherein the thermal energy storage unit has a thickness of 0.125 m to 3.0 m and is formed from hollow core slabs.

23. The system of claim 13, wherein the transparent cover comprises two panes of transparent material separated by a space therebetween, and wherein a substantial vacuum is formed in the space, or an aerogel material is placed in the space.

24. The system of claim 13, wherein the system incorporates geothermal heat, other waste heat streams, or electrical resistive materials instead of or in addition to solar radiation.

25. The system of claim 13, wherein the sealed compartment is filled with one of:
substantial vacuum, argon gas, or air.

26. The system of claim 13, wherein the transparent cover transmits solar radiation, and minimizes radiative and convective heat loss.
